(19) United States
(12) Patent Application Publication
(10) Pub. No.: US 2012/0131511 A1
(43) Pub. Date: May 24, 2012

(54) OUTPUT APPARATUS AND METHOD FOR PORTABLE TERMINAL

(75) Inventor: Bum-Sun Park, Anyang-si (KR)

(73) Assignee: SAMSUNG ELECTRONICS CO., LTD., Suwon-si (KR)

(21) Appl. No.: 13/303,014

(22) Filed: Nov. 22, 2011

(30) Foreign Application Priority Data
Nov. 22, 2010 (KR) 10-2010-0116326

(51) Int. Cl. G06F 3/048

(52) U.S. Cl. 715/841

(57) ABSTRACT

An output apparatus capable of grouping menu items is configured for operation of a portable terminal into items with similar functions and outputting the grouped items. The apparatus includes an output management unit for determining sub-menu items included in a selected menu item when a user selects the menu item and determining sub-menu items having correlation with the selected menu item and a controller for outputting the sub-menu items determined by the output management unit together.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 22, 2010 and assigned Serial No. 10-2010-0116326, the entire disclosure of which is hereby incorporated by reference.

### TECHNICAL FIELD OF THE INVENTION

The present invention relates to an output apparatus and method for a portable terminal. More particularly, the present invention relates to an output apparatus and method for grouping menu items configured for operation of a portable terminal into items with similar functions and outputting the grouped items.

### BACKGROUND OF THE INVENTION

Portable terminals have become necessities of modern life for people of all ages. Thus, service providers and terminal manufacturers are competitively developing differentiated products (or services).

For example, the portable terminal has developed into a multimedia device capable of providing various functions such as a phonebook function, a game function, a short message function, an e-mail function, a wake-up call function, an MPEG-1 Audio Layer 3 (MP3) function, a scheduling function, a digital camera function, a multimedia message function, and a wireless Internet function.

The aforementioned functions are connected to a menu interface. The menu interface is composed of a plurality of menu items.

FIGS. 1A-1C illustrate a configuration of a menu interface provided in a conventional portable terminal.

Referring to FIG. 1A, the portable terminal displays a plurality of main menu items 101. Each of the main menu items includes a plurality of sub-menu items.

That is, when a main menu item is selected, the portable terminal outputs a plurality of sub-menu items included in the main menu item. The menu interface has a hierarchical structure shown in FIG. 1B.

For example, if a user of the portable terminal selects a main menu item 103 about bell sounds, the portable terminal outputs sub-menu items 105 such as a reception bell selection item, a notification sound item for conditions, an operation sound item, and a volume adjustment item.

When the user selects the reception bell selection item, the portable terminal outputs sub-menu items 105 such as a bell/vibration item, a download item, and a my own bell item.

Also, if the user selects a main menu item 107 about setup, the portable terminal outputs sub-menu items 109 such as a call establishment item, a function setup item, and a password setup item as shown in (c) of FIG. 1. If the user selects the function setup item, the portable terminal outputs sub-menu items 109 such as a picture setup item, a sound setup item, a message setup item, and a camera setup item.

Because the above-mentioned menu interface has the hierarchical structure, the user must select a sub-menu item after entering a main menu item. Accordingly, the user must recognize sub-menu items included in respective main menu items.

However, the aforementioned hierarchical structure of the menu interface is not provided by a made rule. Because each of terminal manufacturers provides a different hierarchical structure of the menu interface, a user who wants to select a menu suffers much inconvenience.

For example, because the user recognizes a sound setup item 111 included in the function setup item as a sub-menu item included in the main menu item 103, he/she may enter the main menu item 103. However, actually, because the sound setup function 111 is included in the function setup item, the portable terminal has a problem in that the user enter the main menu item 107 once more to fine the sound setup item 111.

Therefore, in order to solve the above-mentioned problem, an apparatus and method for outputting menu items having a function which is similar to a function of a selected item in the portable terminal is needed.

### SUMMARY OF THE INVENTION

To address the above-discussed deficiencies of the prior art, it is a primary object to provide at least the advantages described below. Accordingly, an aspect of the present disclosure is to provide an apparatus and method for simplifying a menu selection process in a portable terminal.

Another aspect of the present disclosure is to provide an apparatus and method for outputting menu items having a function which is similar to a function of a selected menu item together in a portable terminal.

Another aspect of the present disclosure is to provide an apparatus and method for applying tags indicating attributes to a menu item in a portable terminal.

Another aspect of the present disclosure is to provide an apparatus and method for determining a sub-menu item to which a tag similar to an attribute of a selected menu is applied in a portable terminal.

In accordance with an aspect of the present disclosure, an output apparatus for a portable terminal is provided. The apparatus includes an output management unit that determines sub-menu items included in a selected menu item when a user selects the menu item and determines sub-menu items having correlation with the selected menu item and a controller that outputs the sub-menu items determined by the output management unit together.

In accordance with another aspect of the present disclosure, an output method for a portable terminal is provided. The method includes determining sub-menu items included in a selected menu when a user selects the menu item, determining sub-menu items having correlation with the selected menu, and outputting, the determined sub-menu items together.

In accordance with an aspect of the present disclosure, an output apparatus for a portable terminal is provided. The apparatus includes an input unit that generates key input data for selecting a menu item, a display unit that divides an output region into a plurality of regions and outputs corresponding menu items on the divided regions, a tag application unit that applies tags to the respective menu items, a priority determination unit that sets priorities for the applied tags and determining priorities for selected menu items, an output management unit that outputs menu items having a tag which is similar to an attribute of the selected menu item according to the priorities when a user selects the menu item, and a controller that controls the display unit to output the menu items output by the output management unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present disclosure will be more apparent from the following detailed description taken in conjunction with the accompanying drawings, in which:

FIGS. 1 A through 1C illustrates a configuration of a menu interface provided in a conventional portable terminal;

FIG. 2 illustrates a configuration of a portable terminal which outputs menu items according to an exemplary embodiment of a present disclosure;

FIG. 3A and 3B illustrate a menu item output process of a portable terminal according to an exemplary embodiment of the present disclosure;

FIG. 4A and 4B illustrate a menu item output picture of a portable terminal according to an exemplary embodiment of the present disclosure; and

FIG. 5A and 5B illustrate a picture of a portable terminal which provides a main menu item corresponding to a sound according to an exemplary embodiment of the present disclosure.

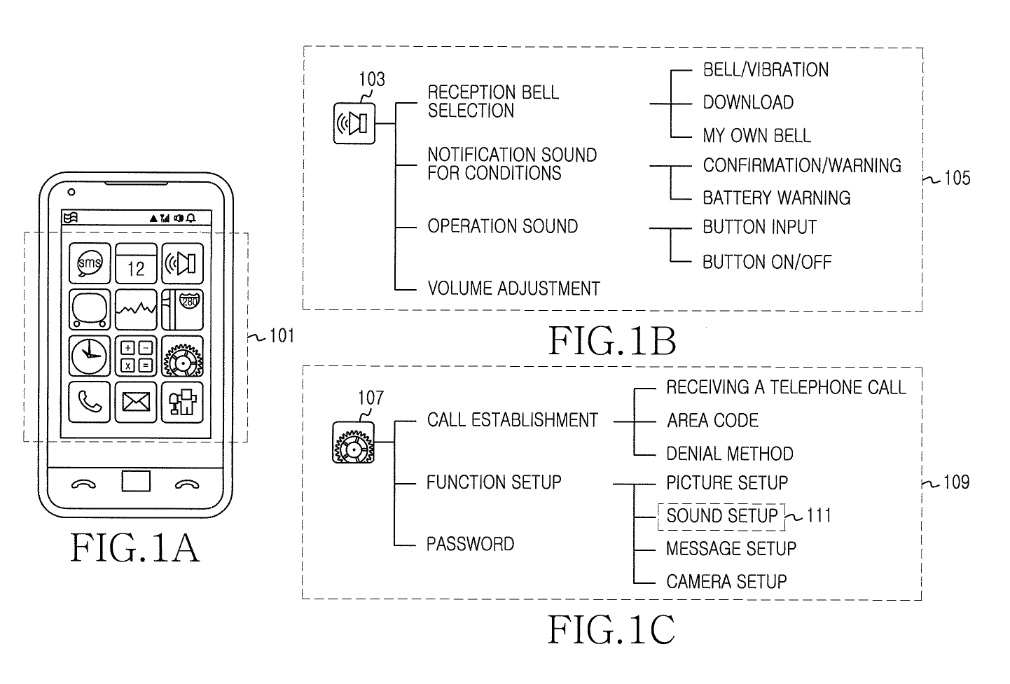

Throughout the drawings, like reference numerals will be understood to refer to like parts, components and structures.

### DETAILED DESCRIPTION OF THE INVENTION

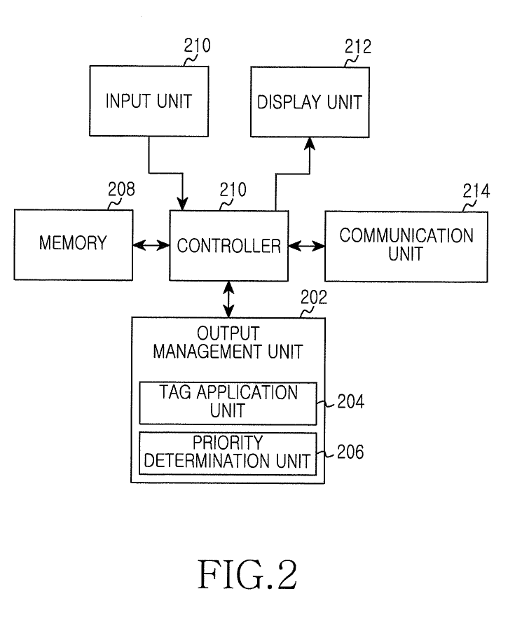

FIGS. 2 through 5B, discussed below, and the various embodiments used to describe the principles of the present disclosure in this patent document are by way of illustration only and should not be construed in any way to limit the scope of the disclosure.

Exemplary embodiments of the present disclosure will be described herein below with reference to the accompanying drawings. In the following description, well-known functions or constructions are not described in detail since they would obscure the invention in unnecessary detail.

The present disclosure described hereinafter relates to an apparatus and method for outputting menu items having a function which is similar to a function of a selected menu item and simplifying a menu selection process in a portable terminal according to an exemplary embodiment of the present invention.

FIG. 2 illustrates configuration of a portable terminal which outputs a menu item according to an exemplary embodiment of the present disclosure.

Referring to FIG. 2, the portable terminal includes a controller 200, an output management unit 202, a memory 208, an input unit 210, a display unit 212, and a communication unit 214. The output management unit 202 includes a tag application unit 204 and a priority determination unit 206.

The controller 200 of the portable terminal controls an overall operation of the portable terminal. For example, the controller 200 performs process and control for voice telephone conversation and data communication. Also, the controller 200 controls the display unit 212 according to an exemplary embodiment of the present invention to divide an output picture and classify and output sub-menu items to be outputted to the divided regions.

That is, the controller 200 controls the output management unit 202 to apply tags indicating attributes to respective sub-menu items, determine the tags, and determine menu items having correlation with a menu item selected by a user.

The controller 200 controls the display unit 212 to output sub-menu items included in a main menu item selected among the determined menu items on a main picture and output menu items which are not included in the main menu item and have correlation with the main menu item on a sub-picture.

The output management unit 202 classifies sub-menu items to be output to divided regions under control of the controller 200.

In order to perform the aforementioned operation, the output management unit 202 applies tags indicating attributes to menu items configured for operation of the portable terminal and determines priorities of the applied tags.

Also, when a user selects a menu item, the output management unit 202 determines sub-menu items having an attribute which is similar to an attribute of the selected menu item.

The tag application unit 204 of the output management unit 202 applies the tags indicating the attributes of the menu items. The tag application unit 204 can apply the tags according to attributes of words configuring the menu items. For example, the tag application unit 204 can apply two tags, a “camera” and a “sound”, to a “camera sound” menu item.

The priority determination unit 206 of the output management unit 202 determines priorities of the tags applied by the tag application unit 204. Here, the priority is used for deciding rankings of sub-menu items for a main menu item. The priority determination unit 206 decides the rankings of the sub-menu items for the main menu item using the priorities of the tags.

If a ranking of the tag corresponding to the “camera” is determined at number one and a ranking of the tag corresponding to the “sound” is determined at number two with respect to the “camera sound” sub-menu item, the “camera sound” sub-menu item is determined as a first sub-menu item for a main menu item corresponding to the “camera” or a second sub-menu item for a main menu item corresponding to the “sound”.

The memory 208 preferably includes, for example, a Read Only Memory (ROM), a Random Access Memory (RAM), and a flash ROM. The ROM stores a microcode of a program, which performs process and control of the controller 200 and the output management unit 202, and a variety of reference data.

The RAM is a working memory of the controller 200 and stores temporary data that are generated while various programs are performed. The flash ROM stores a variety of rewritable data, such as phonebook entries, outgoing messages, incoming messages and such.

The input unit 210 includes numeral key buttons of ‘0’ to ‘9’ and a plurality of function keys, such as a menu button, a cancel button, an OK button, a talk button, an end button, an Internet access button, a navigation key (or directional key) button, and character input keys. The input unit 210 provides key input data corresponding to a key pushed by a user to the controller 200. According to an exemplary embodiment of the present invention, the input unit 210 generates key input data for selecting menu items.

The display unit 212 displays state information, characters, large volumes of moving and still pictures, etc., which are generated during operation of the portable terminal. The display unit 212 can be a color Liquid Crystal Display (LCD), Active Mode Organic Light Emitting Diode (AMOLED), and such. The display unit 212 can include a touch input device. Accordingly, the display unit 212 can be used as an input device when it is applied to a touch input type portable terminal. According to an exemplary embodiment of the present invention, the display unit 212 divides an output region into a plurality of regions and outputs corresponding menu items on the divided regions.

The communication unit 214 transmits and receives a Radio Frequency (RF) signal of data that are input and output through an antenna (not illustrated). For example, in case of a transmitting process, data to be transmitted are subject to a channel-coding process and a spreading process, and then the data are converted into an RF signal. In case of a receiving process, the RF signal is received and converted into a baseband signal, and the baseband signal is subject to a de-spreading process and a channel-decoding process, thereby restoring the data.

The function of the output management unit 202 can be performed by the controller 200 of the portable terminal. However, the present invention includes the controller 200 and the output management unit 202 which are exemplary configurations for the convenience of explanation and are not limited to a scope of the prevent invention. It will be understood by those skilled in the art that various changes in form and details can be made therein without departing from the spirit and scope of the present invention. For example, the output management unit 202 can be composed to be processed in the controller 200.

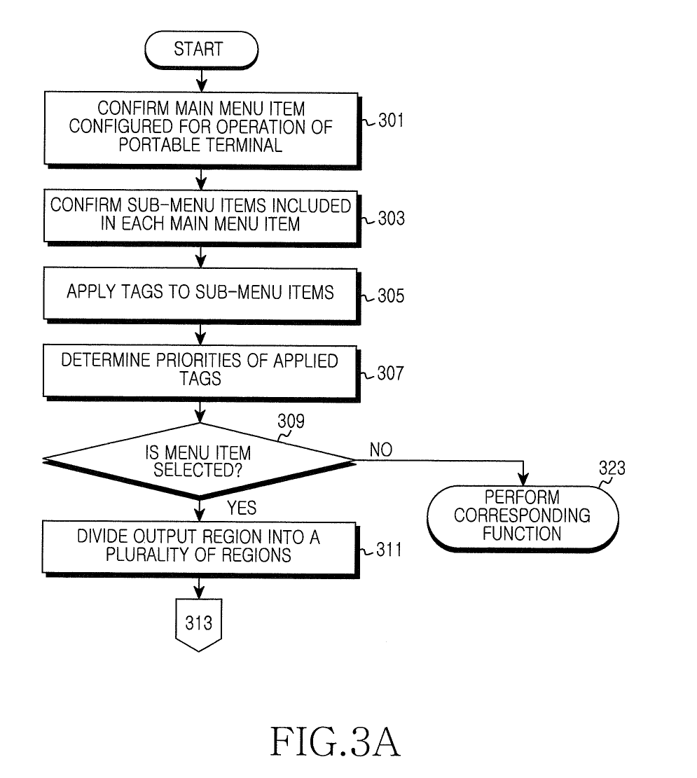

FIGS. 3A and 3B illustrate a menu item output process of a portable terminal according to an embodiment of the present disclosure.

Referring to FIGS. 3A and 3B, the portable terminal determines a main menu item configured for operation of the portable terminal in block 301. Here, the portable terminal is operated by a plurality of menu items. The main menu item includes a plurality of sub-menu items with a hierarchical structure. The main menu item is provided when the portable terminal enters a menu function, and the sub menu item indicates a function for a detailed item of the main menu item.

The portable terminal proceeds to block 303 and determines sub-menu items included in each main menu item. The portable terminal proceeds to block 305 and performs a tag application process of the sub-menu items. Here, in the tag application process, a tag corresponding to a word configuring the sub-menu items is applied. For example, the portable terminal can apply two tags, a “camera” and a “sound adjustment” to a “camera sound adjustment” sub-menu item.

The portable terminal proceeds to block 307 and determines priorities of the applied tags. Here, the priority of the tag is used for determining rankings of sub-menu items for a main menu item.

For example, a ranking of the tag corresponding to the “camera” is at number one and a ranking of the tag corresponding to the “sound adjustment” is at number two with respect to the “camera sound adjustment” sub-menu item, the “camera sound adjustment” sub-menu item is a first sub-menu item with respect to a main menu item corresponding to the “camera” or is a second sub-menu item with respect to a main menu item corresponding to the “sound adjustment”.

The first sub-menu item is included in the main menu item, and the second sub-menu item does not correspond to the first sub-menu item and has a function associated with the main menu item.

The portable terminal proceeds to block 309 and determines whether a user selects any one on a list of menu items for operation of the portable terminal.

If the user does not select a menu item, the portable terminal proceeds to block 323 and performs a corresponding function (e.g., waiting mode).

Meanwhile, when the user selects a menu item in block 309, the portable terminal proceeds to block 311 and divides an output region into a plurality of regions.

The portable terminal determines rankings to the divided respective regions and classifies the divided respective regions. The ranks are determined in the size order of the divided regions. The portable terminal outputs the main menu item and the first sub-menu item on a region (main picture) corresponding to a high ranking and outputs the second sub-menu time on a region (sub-picture) corresponding to a next ranking. That is, the sub-picture outputs menu items having a function associated with the main menu item among sub-menu items which do not belong to the main menu item.

The portable terminal proceeds to block 313 and determines a priority menu item corresponding to the menu item selected in block 309. Here, the priority menu item includes sub-menu items which belong to a main menu item selected by the user and sub-menu items of a function associated with the selected menu item.

The portable terminal proceeds to block 315 and outputs a high ranking menu item, including the main menu item selected by the user and sub-menu items which belong to the main menu item, on the main picture. This method is same to a menu item output method of a conventional portable terminal.

The portable terminal proceeds to block 317 and outputs a low ranking menu item, including sub-menu items of a function associated with the main menu item selected by the user, on the sub-picture.

When the user uses the portable terminal according to an exemplary embodiment of the present disclosure, he/she can determine the selected menu item and sub-menu items having attributes which are similar to attributes of the selected menu item at a time.

The portable terminal which outputs a plurality of the menu items on the main picture and the sub-picture as mentioned above proceeds to block 319 and determines whether the user selects the low ranking menu item output on the sub-picture.

If the user selects the low ranking menu item output on the sub-picture in block 319, the portable terminal proceeds to block 325 and outputs the selected low ranking menu item on the main picture. The portable terminal proceeds to block 317 and outputs a low ranking menu item, including sub-menu items of a function associated with the menu item selected in block 319, on the sub-picture.

Meanwhile, when the user selects the high ranking menu item output on the main picture in block 319, the portable terminal proceeds to block 321, executes the selected specific menu item, and ends the above-mentioned procedure.

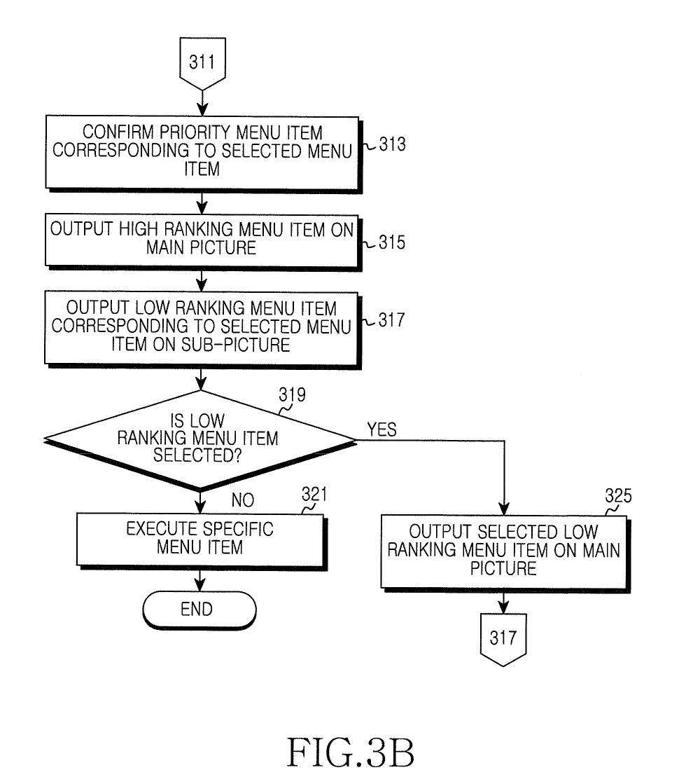

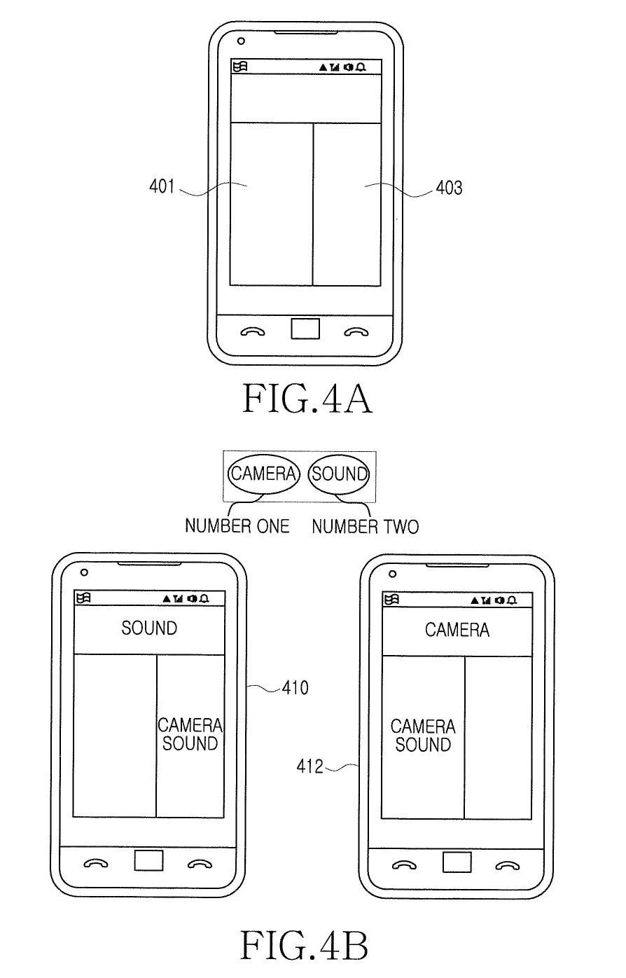

FIGS. 4A and 4B illustrate a menu item output picture of a portable terminal according to an exemplary embodiment of the present disclosure.

Referring to FIGS. 4A and 4B, the portable terminal can divide an output picture into a plurality of regions. For example, the portable terminal can divide an output picture into a main picture 401 and a sub-picture 403 shown in FIG. 4A. The portable terminal outputs a main menu item and sub-menu items included in the main menu item on the main picture 401. Also, the portable terminal outputs sub-menu items having a function associated with the main menu item on the sub-picture 403. That is, the sub-picture 403 outputs the sub-menu items having the function associated with the main menu item among sub-menu items which does not belong to the main menu item.

The main menu item, the sub-menu items, and the sub-menu items having correlation with the main menu item can be defined as follow.

A description will be made of a “camera sound” menu item, for adjusting a sound generated when a camera function is operated, as an example. The “camera sound” menu item can be a sub-menu item included in a “camera” main menu item. Also, the “camera sound” menu item is similar to a “sound” menu item for adjusting a sound of the portable terminal and is not included in the “sound” menu item. Generally, the user of the portable terminal can recognize that the “camera sound” menu item is included in the “sound” main menu item. In this case, a user enters the “sound” main menu item and searches the “camera sound” menu item. However, because the “camera sound” menu item does not exist in the “sound” main menu, the portable terminal has a problem in that the user enters a different main menu once more.

In order to solve the aforementioned problem, the portable terminal according to an exemplary embodiment of the present disclosure outputs sub-menu items for a main menu item selected by the user together with sub-menu items having a function correlation with the main menu item.

In order to perform the above-mentioned operation, the portable terminal can apply tags to menu items configured for the operation of the portable terminal, and can determine sub-menu items having correlation with a menu item selected by the user using the applied tags.

For example, the portable terminal applies tags, a “camera” and a “sound”, to a “camera sound” sub-menu item shown in FIG. 4B. When a main menu item associated with the “camera” or the “sound” is selected, the “camera sound” menu item to which the tags are applied can be output as a sub-menu item. Also, the portable terminal determines priorities for the applied tags.

The priority is used for determining rankings of sub-menu items for a main menu item. If a ranking of the tag corresponding to the “camera” is at number one and a ranking of the tag corresponding to the “sound” is at number two with respect to the “camera sound” sub-menu, the “camera sound” sub-menu item is a first menu item of the “camera” main menu item 412 or a second sub-menu item of the “sound” main menu item 410.

In this case, when the user selects the “sound” main menu item, the portable terminal can output the “camera sound” sub-menu item on the sub-picture. When the user selects the “camera” main menu item, the portable terminal can output the “camera sound” sub-menu item on the main picture. The portable terminal can output sub-menu items (e.g., storage image, image editing, and the like) having correlation with the “camera” main menu item on the sub-picture through the above-mentioned method.

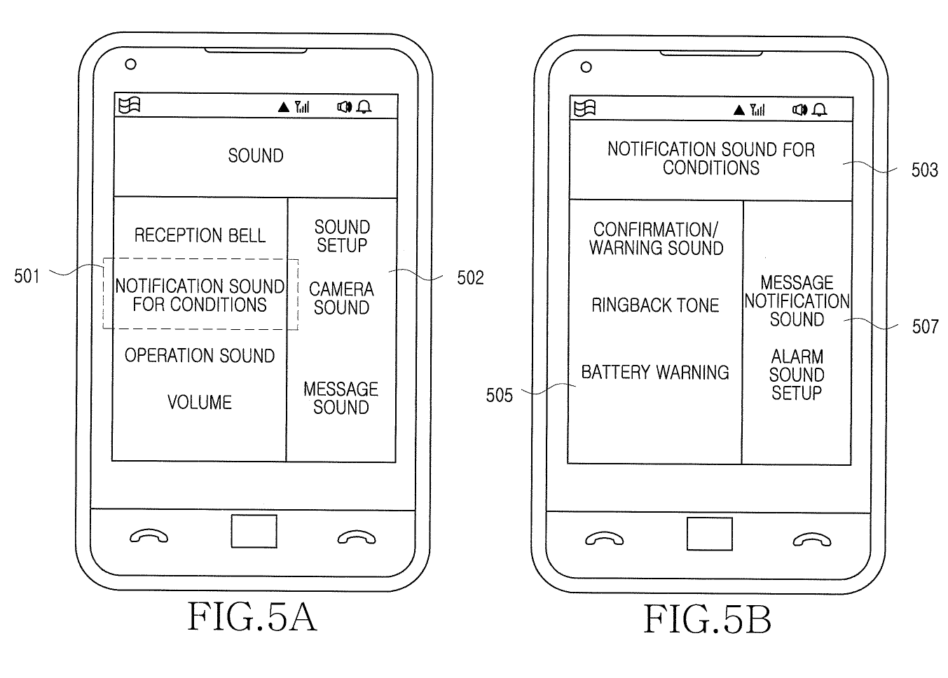

FIGS. 5A and 5B illustrate a picture of a portable terminal that provides a main menu item corresponding to a sound according to an exemplary embodiment of the present disclosure.

Referring to FIGS. 5A and 5B, the portable terminal provides a “sound” main menu item including a reception bell item, a notification sound item for conditions, an operation sound item, a volume item, and the like.

If a user selects the “sound” main menu item, a general portable terminal outputs sub-menu items such as a reception bell item, a notification sound item for conditions, an operation sound item, and a volume item.

However, as shown in FIG. 5A, a portable terminal according to an exemplary embodiment of the present disclosure determines sub-menu items (sound setup item, camera sound item, and message setup item) having correlation with the “sound” main menu item among tags of a sub-menu item, which are previously applied, and outputs the determined sub-menu items on a sub-picture 502.

If the user of the portable terminal selects any one of the sub-menu items which are previously output, the portable terminal changes an output location of the selected sub-menu item.

For example, as shown in FIG. 58, when the user of the portable terminal selects a notification sound item for conditions which is previously output, the portable terminal outputs sub-menu items corresponding to the notification sound item for conditions on a location where the sub-menu items corresponding to the “sound” main menu item are output 505. The portable terminal replaces the sub-menu items corresponding to the “sound” main menu item with sub-menu items (e.g., message notification sound item, alarm sound setup item, and the like) having correlation with the notification sound item for conditions on the sub-picture 507. The portable terminal can display that it enters the notification sound item for conditions according to selection of the user 503.

As mentioned above, the present disclosure relates to an apparatus and method for simplifying a menu selection process. The present disclosure solves a problem in that a user must directly recognize a location where sub-menu items exist by outputting menu items having a function which is similar to a function of a selected menu item in the portable terminal.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. An output apparatus of a portable terminal, the apparatus comprising:
an output management unit configured to determine sub-menu items included in a selected menu item when a user selects the menu item and determine sub-menu items having correlation with the selected menu item; and
a controller configured to output the sub-menu items determined by the output management unit together.

2. The apparatus of claim 1, wherein the output management unit comprises a tag application unit configured to apply tags to the respective menu items and determine a menu item having a tag which is similar to an attribute of the selected menu item.

3. The apparatus of claim 2, wherein the tag application unit is configured to set priorities for the applied tags after applying the tags to the respective menu items and determine rankings of sub-menu items for the selected menu item.

4. The apparatus of claim 1, wherein the controller is configured to divide an output picture into a plurality of regions, designate the divided regions as a main picture and a sub-picture, output the sub-menu items included in the selected menu item on the main picture, and output the sub-menu items having correlation with the selected menu on the sub-picture.

5. The apparatus of claim 4, wherein the controller is configured to move a selected sub-menu item to the main picture when the user selects the output sub-menu item.

6. The apparatus of claim 5, wherein the controller is configured to output a different sub-menu associated with the sub-menu item after moving the sub-menu item to the main picture.

7. The apparatus of claim 1, wherein the display unit is a touch input device.

8. The apparatus of claim 1, wherein the display unit comprises one of:
a color Liquid Crystal Display (LCD), Active Mode Organic Light Emitting Diode (AMOLED).

9. An output method for a portable terminal, the method comprising:
determining sub-menu items included in a selected menu when a user selects the menu item;
determining sub-menu items having correlation with the selected menu; and
outputting the determined sub-menu items together.

10. The method of claim 9, wherein the determination of the sub-menu items having the correlation with the selected menu item comprises:
applying tags to the respective menu items; and
determining a menu item having a tag which is similar to an attribute of the selected menu item.

11. The method of claim 10, wherein the determination of the sub-menu items included in the selected menu item comprises:
setting priorities for the applied tags after applying the tags to the respective menu items; and
determining rankings of the sub-menu items for the selected menu items.

12. The method of claim 9, wherein the outputting of the determined sub-menu items comprises:
dividing an output picture into a plurality of regions;
designating the divided regions as a main picture and a sub-picture;

13. The method of claim 12, wherein the outputting of the determined sub-menu items comprises:
outputting the sub-menu items included in the selected menu item on the main picture; and
outputting the sub-menu items having the correlation with the selected menu item on the sub-picture.

14. The method of claim 13, wherein the outputting of the determined sub-menu items further comprises moving a selected sub-menu item to the main picture when the user selects the output sub-menu item.

15. The method of claim 12, wherein the outputting of the determined sub-menu items further comprises outputting a different sub-menu item associated with the sub-menu time on the sub-picture after moving the sub-menu item to the main picture.

16. An output apparatus of a portable terminal, the apparatus comprising:
an input unit configured to generate key input data for selecting a menu item;
a display unit configured to divide an output region into a plurality of regions and output corresponding menu items on the divided regions;
a tag application unit configured to apply tags to the respective menu items;
a priority determination unit configured to set priorities for the applied tags and determine priorities for selected menu items;
an output management unit configured to output menu items having a tag which is similar to an attribute of the selected menu item according to the priorities when a user selects the menu item; and
a controller configured to control the display unit to output the menu items output by the output management unit.

17. The apparatus of claim 16, wherein the output management unit is configured to divide an output picture into a plurality of regions, and designate the divided regions as a main picture and a sub-picture output sub-menu items included in the selected menu item on the main picture, and output sub-menu items having correlation with the selected menu item on the sub-picture.

18. The apparatus of claim 17, wherein the output management unit is configured to move a selected sub-menu item to the main picture when the user selects the output sub-menu item.

19. The apparatus of claim 16, wherein the display unit is a touch input device.

20. The apparatus of claim 19, wherein the display unit comprises one of: a color Liquid Crystal Display (LCD), Active Mode Organic Light Emitting Diode (AMOLED).
